(19) United States
(12) Patent Application Publication
(10) Pub. No.: US 2016/0101317 A1
(43) Pub. Date: Apr. 14, 2016

(54) SWING EVALUATION APPARATUS, SWING EVALUATION METHOD, AND SWING EVALUATION PROGRAM

(71) Applicant: SEIKO EPSON CORPORATION, Tokyo (JP)

(72) Inventors: Nobuyuki KITO, Shiojiri-shi (JP); Takuya NAKAYAMA, Shiojiri-shi (JP)

(21) Appl. No.: 14/873,512

(22) Filed: Oct. 2, 2015

(30) Foreign Application Priority Data
Oct. 8, 2014 (JP) 2014-207371

(51) Int. Cl. A63B 24/00; A63B 71/06; G01P 15/00

(52) U.S. Cl. CPC A63B 24/0006; G01P 15/00; A63B 71/0619; A63B 2071/0655

(57) ABSTRACT

A swing evaluation apparatus includes an analysis unit which calculates an analytical value relating to a swing based on an output of an inertia sensor; an evaluation unit which evaluates a degree of achievement of the analytical value with respect to a set target value; and a notifying unit which notifies a user of an evaluation result by changing types of notification in accordance with the degree of achievement. In this way, the degree of achievement with respect to a target is notified to the user.

### BACKGROUND

1. Technical Field

The present invention relates to a swing evaluation apparatus, a swing evaluation method, and a swing evaluation program.

2. Related Art

JP-A-10-43349 discloses a swing diagnostic device. The swing diagnostic device is provided with an acceleration sensor. The acceleration sensor detects the acceleration of a club head in time series during golf swing. Based on variation of the acceleration, it is possible to specify a moment the wrist is curved and timing to hit a ball. A ball-hitting direction is specified in accordance with a time lag between the moment the wrist is curved and the timing to hit the ball.

JP-A-10-43349 discloses that the swing diagnostic device analyzes the ball-hitting direction and notifies a user of an analyzed result with sound. Various types of sound are used for each ball path such as hook, straight, or slice. The user can recognize the ball-hitting direction without any additional action simply by swinging a club. This is convenient and promotes an effect of training.

### SUMMARY

An advantage of some aspects of the invention is to provide a swing evaluation apparatus, a swing evaluation method, and a swing evaluation program which are capable of prompting effects of training.

(1) An aspect of the invention relates to a swing evaluation apparatus including an analysis unit which calculates an analytical value relating to a swing based on an output of an inertia sensor; an evaluation unit which evaluates a degree of achievement of the analytical value with respect to a set target value; and a notifying unit which notifies a user of an evaluation result by changing types of notification in accordance with the degree of achievement.

When a user swings a bat, a club, a racket, or the like, a detection signal is output from the inertia sensor. The detection signal is input to the analysis unit. The analysis unit calculates the analytical value relating to the swing in accordance with the input detection signal. The calculated analytical value is transferred to the evaluation unit. The evaluation unit evaluates the degree of achievement of the analytical value with respect to the target value by comparing the target value with the analytical value. The evaluation result is transferred to the notifying unit. The types of the notification are changed in accordance with the degree of achievement. In this way, the degree of achievement with respect to the target is notified to the user. Every time the user swings, the user can recognize whether a swing is correct or not in accordance with the degree of achievement of which the user is notified. It is possible to realize effective training.

(2) The notifying unit may notify the user of the evaluation result by using at least one of sound, light, and vibration. The user can recognize the degree of achievement with respect to a target without any additional action simply by swinging. This is convenient and prompts an effect of training.

(3) The notifying unit may be integrally provided with a unit in which the inertia sensor is accommodated. In this way, when an output unit is integrally formed with the inertia sensor, manipulation of the output unit is simplified compared with a case where the output unit is separately formed from the inertia sensor. In addition, since a mounting mechanism of the output unit is used in common as the inertia sensor, it is possible to make a simple structure.

(4) The notifying unit may be separately provided from the unit in which the inertia sensor is accommodated. For example, the notifying unit can be separately mounted from the unit by the user. The output sound, the light, and the vibration ensure stimulation of the senses of the user. The degree of achievement with respect to the target is surely transferred to the user.

(5) Another aspect of the invention relates to a swing evaluation apparatus including an analysis unit which calculates analytical values relating to a plurality of swings based on an output of an inertia sensor; an evaluation unit which evaluates achievement or non-achievement of the analytical value for at least one of the plurality of swings with respect to a set target value; a group evaluation unit which evaluates a degree of achievement with respect to the target value as a swing group; and a notifying unit which notifies a user of the degree of achievement.

The group evaluation unit evaluates achievement or non-achievement with respect to the target value for at least one of the swings. Then, the group evaluation unit evaluates the degree of target achievement with the swing group which is an aggregate of swings. In this way, the entirety of swing groups is evaluated. The collective analysis as the swing group is realized.

(6) The group evaluation unit may update the target value in accordance with the evaluation of the swing group. The group evaluation unit changes the target value in accordance with a degree of attainment of a user without waiting for designation or operation of the user. In this way, it is possible to automatically set the target value which is effective for the user.

(7) The swing evaluation apparatus may further include an input unit which inputs the target value. The user can designate the target value. In addition, the user can change the target value in accordance with the user's own degree of attainment.

(8) The evaluation unit may perform evaluation in accordance with the degree of achievement in stages. In this way, the degree of achievement is notified to the user in stages. The user can instantaneously confirm the degree of achievement. The user can adopt a training method which is effective in accordance with the degree of achievement.

(9) The notifying unit may perform notification when receiving an evaluation result from the evaluation unit without waiting for the end of the swing. In this way, the user can recognize the degree of achievement with respect to the target while swinging.

(10) Still another aspect of the invention relates to a swing evaluation method including calculating an analytical value relating to a swing based on an output of an inertia sensor; evaluating a degree of achievement of the analytical value with respect to a set target value; and notifying a user of an evaluation result by changing types of notification in accordance with the degree of achievement.

(11) Yet another aspect of the invention relates to a swing evaluation method including calculating analytical values relating to a plurality of swings based on an output of an inertia sensor; evaluating achievement or non-achievement of the analytical value for at least one of the plurality of swings with respect to a set target value; evaluating a degree of achievement with respect to the target value as a swing group; and notifying a user of the degree of achievement.

(12) Still yet another aspect of the invention relates to a swing evaluation program causing a computer to execute: calculating an analytical value relating to a swing based on an output of an inertia sensor; evaluating a degree of achievement of the analytical value with respect to a set target value; and notifying a user of an evaluation result by changing types of notification in accordance with the degree of achievement.

(13) Further another aspect of the invention relates to a swing evaluation program causing a computer to execute: calculating analytical values relating to a plurality of swings based on an output of an inertia sensor; evaluating achievement or non-achievement of the analytical value for at least one of the plurality of swings with respect to a set target value; evaluating a degree of achievement with respect to the target value as a swing group; and notifying a user of the degree of achievement.

### BRIEF DESCRIPTION OF THE DRAWINGS

The invention will be described with reference to the accompanying drawings, wherein like numbers reference like elements.

FIG. 1 is a conceptual diagram schematically illustrating a configuration of a swing evaluation apparatus.

FIG. 2 is a block diagram schematically illustrating a configuration of the swing evaluation apparatus.

FIG. 3 is a flow chart schematically illustrating a swing evaluation method.

FIG. 4 is a plan view of a smart phone illustrating a specific example of a screen.

FIG. 5 is a plan view of the smart phone illustrating a specific example of a screen.

FIG. 6 is a plan view of the smart phone illustrating a specific example of a screen.

FIG. 7 is a diagram illustrating a concept of a reference value.

FIG. 8 is a diagram illustrating a concept of a reference value.

### DESCRIPTION OF EXEMPLARY EMBODIMENTS

Hereinafter, an embodiment of the invention will be described with reference to accompanying drawings. Note that, the embodiment in the following description is not unjustly limited to the content of the invention described in the scope of an aspect of the invention, and it is not limited that all configurations described in the present invention are necessary as means for solving a problem of the invention.

### 1. Configuration of Swing Evaluation Apparatus

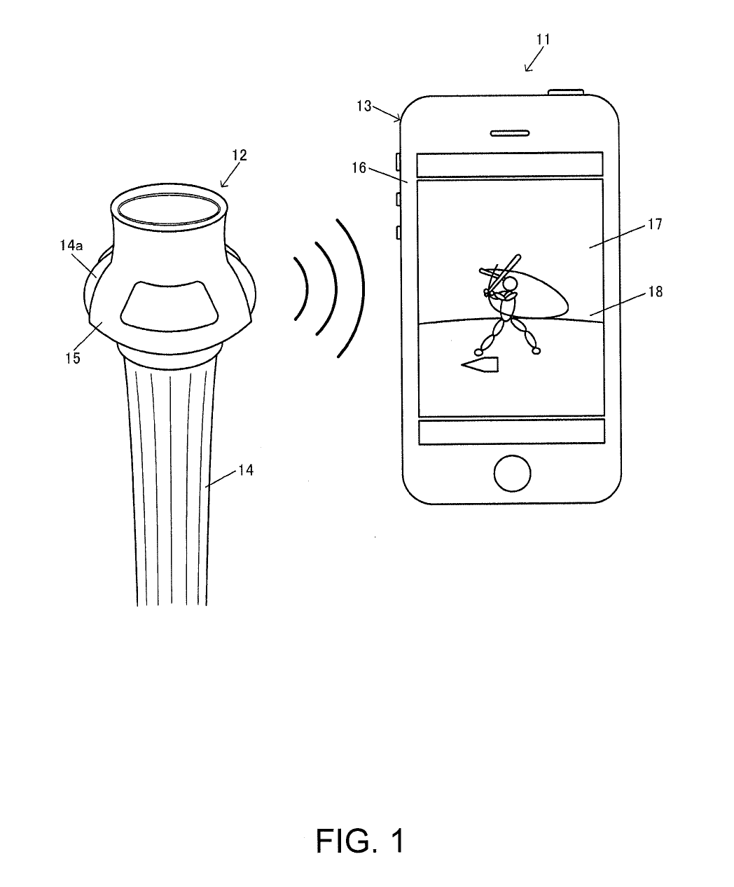

As illustrated in FIG. 1, a swing evaluation apparatus 11 is provided with a sensor device 12 and a host terminal 13. The sensor device 12 is mounted on a bat 14 for, for example, baseball or softball. The sensor device 12 is attached to a grip end 14a of the bat 14 by a mount member 15. The sensor device 12 is preferably embedded in the mount member 15. The mount member 15 is preferably formed of, for example, a freely expandable material.

The host terminal 13 is formed of, for example, a smart phone 16. The smart phone 16 is provided with a display panel 17. A surface of the display panel 17 is overlapped with a touch screen panel 18. A user can confirm an evaluation result of a swing group in accordance with a display of the display panel 17. In the same way, the user can input various instructions and conditions in accordance with an operation of the touch screen panel 18. In addition, it is possible to use a tablet PC terminal, a notebook PC terminal, and a desktop PC terminal in the host terminal 13.

The sensor device 12 is wirelessly connected to communicate with the smart phone 16, for example. It is possible to use, for example, Bluetooth (a trademark) in wireless communication. In this way, a detection signal of the sensor device 12 is supplied to the smart phone 16.

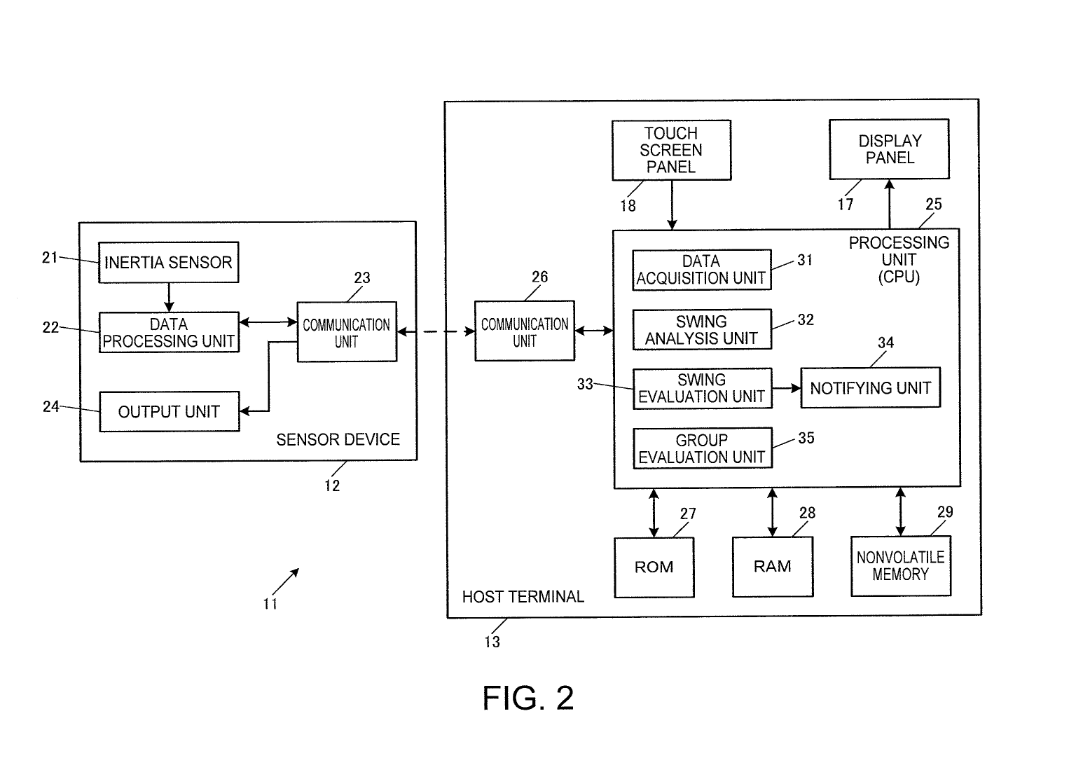

As illustrated in FIG. 2, the sensor device 12 is provided with an inertia sensor 21. The inertia sensor 21 includes an acceleration sensor and a gyrosensor. The acceleration sensor can detect acceleration in each of three axial directions which are perpendicular to one another. The gyrosensor can individually detect angular velocity around each of the three axes which are perpendicular to one another. The inertia sensor 21 outputs the detection signal. The detection signal specifies inertia quantity. That is, the acceleration and the angular velocity for each axis are specified by the detection signal.

The sensor device 12 includes a data processing unit 22. The data processing unit 22 is connected to the inertia sensor 21. The detection signal is supplied to the data processing unit 22 from the inertia sensor 21. The detection signal is processed in the data processing unit 22 and then converted into a signal which is suitable for communication. For example, an analog signal is converted into a digital signal.

The sensor device 12 includes a communication unit 23. The communication unit 23 is connected to the data processing unit 22. The detection signal which is processed in the data processing unit 22 is supplied to the communication unit 23. The communication unit 23 wirelessly outputs the detection signal according to a determined communication protocol.

The sensor device 12 includes an output unit 24. The output unit 24 is connected to the communication unit 23. Here, the output unit 24 is provided with, for example, a speaker. The output unit 24 outputs sound in accordance with reception of a notice signal which is received from the communication unit 23. The output unit 24 outputs sound which is predetermined by the speaker according to the designation of the notice signal. The output unit 24 may be provided with a light emitting element and (or) a vibrating element (vibrator) instead of the speaker, or in addition to the speaker. The light emitting element may emit the light which is predetermined according to the designation of the notice signal. The vibrating element may vibrate with a size or timing which is predetermined according to the designation of the notice signal.

The host terminal 13 includes a processing unit 25. The processing unit 25 is formed as, for example, a CPU. The processing unit 25 is connected to a communication unit 26. The communication unit 26 is capable of wirelessly exchanging signals with the communication unit 23 of the sensor device 12. In this way, the processing unit 25 can process an output signal of the sensor device 12. The display panel 17 and the touch screen panel 18 are connected to the processing unit 25. The processing unit 25 can output a processing result to the display panel 17, and execute an operation which is determined according to manipulation of the touch screen panel 18.

The processing unit 25 is connected to a memory unit such as a read only memory (ROM) 27, a random access memory (RAM) 28, and a nonvolatile memory 29. The processing unit 25 uses the ROM 27, the RAM 28, and the nonvolatile memory 29 so as to process the signal. A swing evaluation software program and relevant data are stored in the ROM 27. The processing unit 25 realizes a swing evaluation method by executing the swing evaluation software program. For example, in order to execute the swing evaluation method, the swing evaluation software program is temporarily stored in the RAM 28. It is possible to store a program and data, which have relatively small capacity, such as a basic input/output system (BIOS) in the nonvolatile memory 29.

The processing unit 25 is provided with a data acquisition unit 31, a swing analysis unit 32, and a swing evaluation unit 33. The data acquisition unit 31 acquires output data of the sensor device 12 which is received via the communication unit 26. The data acquisition unit 31 stores the acquired output data in the RAM 28, for example. It is possible to store the output data in the RAM. 28 in time series.

The swing analysis unit 32 calculates swing analysis information based on the output data which is obtained by the data acquisition unit 31. The swing analysis information includes an analytical value in each item for at least one of the swings. A swing speed, a swing time, a radius of rotation of the grip, an angle of the bat 14, a rotation angle of the bat 14, a swing reaction time, and the like are included in the item. The swing speed specifies a head speed of the bat 14. The swing time specifies a time which has elapsed since the end of the previous swing to the end of the current swing. The radius of rotation of the grip specifies a rotating track radius of a grip end 14a. The angle of the bat 14 specifies an inclination angle of the bat 14 with respect to a horizontal surface. The rotation angle of the bat 14 specifies the rotation angle of the bat 14 around the vertical axis. The swing reaction time specifies a time from a start signal to the maximum speed point of the head speed. In addition, the swing reaction time may specify a time from the start signal until the bat 14 hits a ball, may specify a time from the start of the swing to the maximum speed point, or may specify a time from the start of the swing until the bat 14 hits the ball. Among these items, anyone item may be calculated, an item group including several items may be calculated, or all of the items may be calculated. The swing analysis information which is obtained in this way is specified based on the track or posture of the bat 14 during the swing. A signal which specifies an analytical value is output to, for example, the RAM 28 from the swing analysis unit 32. The swing analysis information is preferably stored in, for example, the RAM 28 for at least one of the swings.

The swing evaluation unit 33 executes an analysis for at least one of the swings. In order to execute the analysis, the swing evaluation unit 33 specifies a target value for each item of the swing analysis information. The swing evaluation unit 33 acquires a signal which specifies the target value of the item. The target value is preferably stored in the RAM 28 in advance. Here, the target value is preferably set by the designation of the user based on the manipulation of the touch screen panel 18.

The swing evaluation unit 33 compares the analytical values for at least one of the swings. In order to compare the analytical values, the swing evaluation unit 33 receives a signal which specifies the analytical value from the RAM 28. Thus, it is evaluated whether or not the analytical value reaches the target value for at least one of the swings.

The processing unit 25 is further provided with a notifying unit 34. The notifying unit 34 is connected to the swing evaluation unit 33. A signal which specifies an evaluation result for at least one of the swings is input into the notifying unit 34 from the swing evaluation unit 33. The notifying unit 34 outputs a notice signal based on the evaluation result which is specified by the signal. The notice signal is output to the output unit 24 from the communication unit 26. Thus, the notifying unit 34 outputs a signal which induces at least one of the stimulation of the five senses of the user.

The processing unit 25 is further provided with a group evaluation unit 35. The group evaluation unit 35 executes the collective analysis as an aggregate of a plurality of swings, that is, the swing group. Among the swing group, a ratio of the swings that have reached the target value is specified. A target degree of achievement is evaluated by the aggregate of the swing in accordance with the ratio.

### 2. Operation of Swing Evaluation Apparatus According to First Embodiment

In order to a practice swinging of the bat 14, a user attaches the sensor device 12 to the bat 14. The sensor device 12 is fixed to the grip end 14a of the bat 14. The user manipulates the touch screen panel 18 according to, for example, a display on the display panel 17 and starts the swing evaluation software program. In this way, the swing evaluation method is executed.

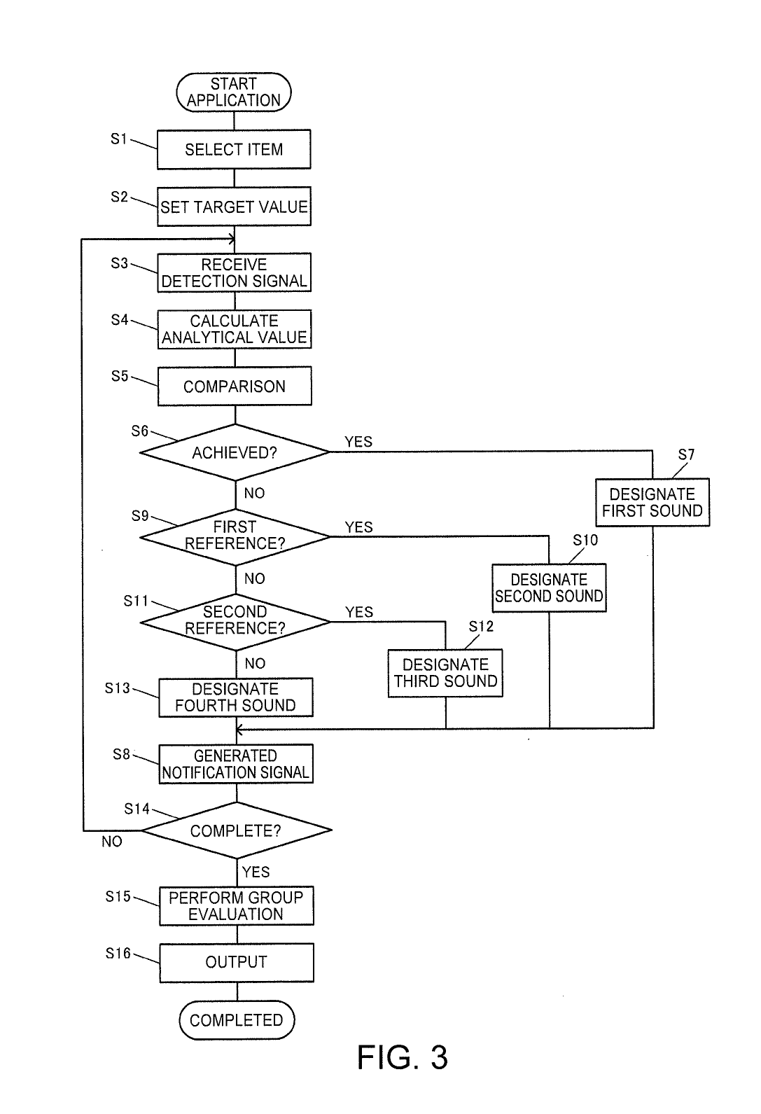

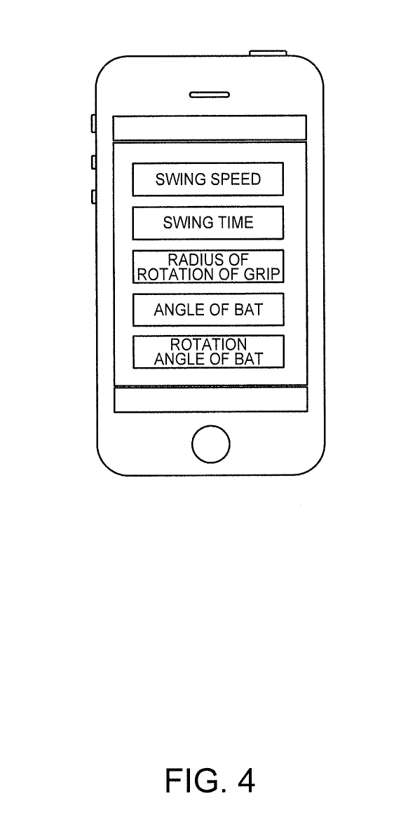

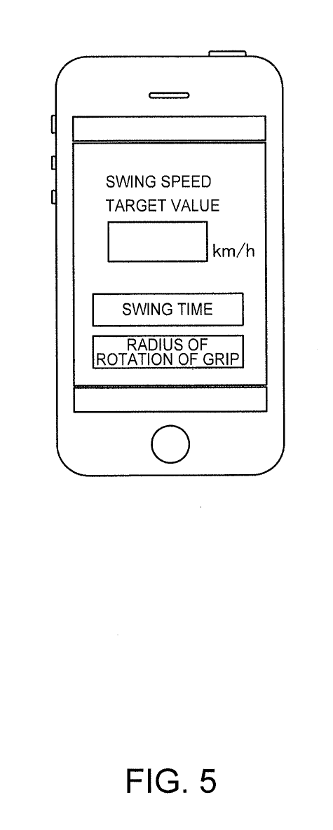

As illustrated in FIG. 3, when the swing evaluation software program is started, the user is prompted to select items in step Si. For example, as illustrated in FIG. 4, items which are supposed to be a target of the degree of achievement are arranged on the screen of the display panel 17. For example, one or more items are selected from the swing speed, the swing time, the radius of rotation of the grip, the angle of the bat 14, the rotation angle of the bat 14, and the swing reaction time. The user sets a target value for each item which is selected in step S2. For example, as the swing speed, the head speed is set to be several kilometers per hour, for example. The target value of the head speed provides the standard of the ball-hitting strength. The swing time is set in the unit of seconds. The target value of the swing time provides a standard pace of the practice swing. The radius of rotation of the grip is set a distance between a grip and a rotation center to be several cm, for example. The target value of the radius of rotation of the grip provides a standard for determining whether the swing is small or large. The angle of the bat 14 is set to be several degrees, for example. The target value of the angle of the bat 14 provides a standard of for example, “the head is upright” or “the head is flat”. The rotation angle of the bat 14 is set to be several degrees, for example. The rotation angle of the bat 14 provides a standard of a full swing and a half swing. The swing reaction time is set in the unit of 1/100 seconds, for example. The swing reaction time provides a standard of the speed of reaction. When setting the above conditions, the user manipulates, for example, the touch screen panel 18. For example, as illustrated in FIG. 5, a blank prompting the input is displayed on the display panel 17. Each of the target values is stored in, for example, the RAM 28. When the setting of the target values is completed, the inertia sensor 21 starts measurement.

During the practice swing, taking a pose and a swing at a hitting place are repeated. During the practice swing, the detection signal is output from the inertia sensor 21. When the user takes a pose, the “pose” is specified in the detection signal of the inertia sensor 21. In typical cases, it is recognized that the “pose” is a stationary state of the grip. When the user swings the bat 14, the detection signal of the inertia sensor 21 changes. In the detection signal, the acceleration other than the gravity acceleration is detected and a change of the angular velocity is specified. The data processing unit 22 processes the detection signal. The processed detection signal is transmitted to the host terminal 13 from the communication unit 23.

In step S3, the communication unit 26 of the host terminal 13 receives a signal. The data acquisition unit 31 acquires output data of the sensor device 12. The output data is stored in the RAM 28 in time series.

In step S4, the swing analysis unit 32 calculates the analytical values of, for at least one of the swings, the swing speed, the swing time, the radius of rotation of the grip, the angle of the bat 14, the rotation angle of the bat 14, and the swing reaction time. Here, the analytical value may be calculated in the selected item. The calculated analytical value is output from the swing analysis unit 32. The analytical value is stored in the RAM 28.

Subsequently, the swing evaluation unit 33 executes the analysis for at least one of the swings. The swing evaluation unit 33 acquires the target value and the analytical value for at least one of the swings from the RAM 28. The analytical value is compared with the target value in step S5. When it is determined that the analytical value is equal to or greater than the target value in step S6, a first sound is designated in step S7. A notice signal which specifies the first sound is generated in step S8. The evaluation result (=achievement) is stored in the RAM 28.

When the analytical value does not reach the target value in step S6, the analytical value is compared with a first reference value in step S9. When it is determined that the analytical value is higher than the first reference value, a second sound is designated in step S10. The second sound is distinguished from the first sound. In order to distinguish the second sound from the first sound, it is preferable to refer to types of sound (sounds of various animals, sounds of various instruments, or the like), a level of sound, rhythm of sound (other than music), or the like. The notice signal which specifies the second sound is generated in step S8. The evaluation result (=non-achievement: higher than the first reference value) is stored in the RAM 28.

When the analytical value does not reach the first reference value in step S9, the analytical value is compared with the second reference value in step S11. When it is determined that the analytical value is higher than the second reference value, a third sound is designated in step S12. In the same way as described above, the third sound is distinguished from each of the first sound and the second sound. The notice signal which specifies the third sound is generated in step S8. The evaluation result (=non-achievement: higher than the second reference value) is stored in the RAM 28.

When the analytical value does not reach the second reference value in step S11, a fourth sound is designated in step S13. In the same way as described above, the fourth sound is distinguished from each of the first sound, the second sound, and the third sound. The notice signal which specifies the fourth sound is generated in step S8. The evaluation result (=non-achievement: equal to or less than the second reference value) is stored in the RAM 28.

The generated notice signal is output from the communication unit 26 to the sensor device 12. The sensor device 12 receives the notice signal in the communication unit 23. The output unit 24 generates sound which is designated by the notice signal. The sound is output from the speaker. In this way, the achievement or the non-achievement with respect to the target is notified to the user. Every time the user swings, the user can recognize whether a swing is good or bad in accordance with the degree of achievement or non-achievement of which the user is notified. It is possible to realize effective training. Particularly, in a case where the target is not achieved, the degree of non-achievement is notified to the user in stages. The user can instantaneously confirm the degree of achievement. The user can adopt a training method which is effective in accordance with the degree of achievement.

It is determined whether or not the practice swing is completed in step S14. If the practice swing is completed, the inertia sensor 21 completes the measurement. If the practice swing is not completed, the inertia sensor 21 continuously performs the measurement. Again, the “pose” is specified in the detection signal of the inertia sensor 21. Until the practice swing is completed, the process afterward is repeated. Even during the practice swing, the inertia sensor 21 can complete the measurement through the manipulation of the touch screen panel 18 by the user.

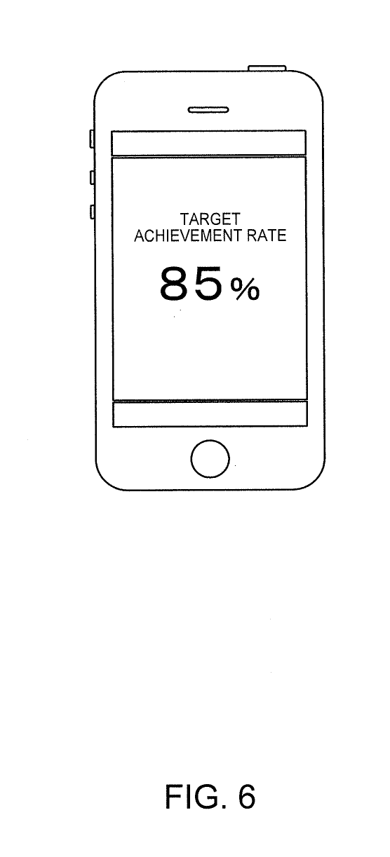

When the inertia sensor 21 completes the measurement, the group evaluation unit 35 executes the analysis of the swing group in step S15. The analysis is preferably started in accordance with the manipulation of the touch screen panel 18 by the user, for example. In order to perform the analysis of the swing group, the group evaluation unit 35 acquires an evaluation result for at least one of the swings from the RAM 28. The swing evaluation unit 33 counts the swings having analytical values which are greater than the target value. The ratio of the analytical values, which are greater than the target value, with respect to the entire number of swings is calculated. The degree of target achievement is evaluated by the swing group in accordance with the ratio. In this way, the entire of the swing groups are evaluated. The collective analysis is realized as the swing group. The group evaluation result is displayed on the display panel 17 in step S16, for example. As illustrated in FIG. 6, the evaluation result of the swing group is notified to the user.

For example, when the swing speed is selected as the item, the ratio in which the swings correspond to the ball-hitting strength which is equal to or greater than the target strength is evaluated. When the swing time is selected as the item, it is possible to evaluate how long or how many times the user takes a break during the practice swing. When the radius of rotation of the grip is selected as the item, it is possible to evaluate the ratio in which the compact swings are achieved. When the angle of the bat 14 is selected as the item, it is possible to evaluate the ratio of the angle of how head lies. When the rotation angle of the bat 14 is selected as the item, the ratio of full swings is evaluated. In this way, it is possible to evaluate the entirety of swing groups based on the ratio of the swings that have reached the target value.

In order to notify the evaluation result, the notifying unit 34 outputs a signal which induces outputs of the first sound to the fourth sound. The user can recognize whether the target is achieved or not by the swing without any additional action. This is convenient and prompts an effect of training. In addition, the same is true for using the light or the vibration instead of the sound.

In the embodiment, the output unit 24 is incorporated into the sensor device 12. The output unit 24 is incorporated into the inertia sensor 21. In this way, when the output unit is integrally formed with the inertia sensor 21, the manipulation of the output unit 24 is simplified compared with a case where the output unit 24 is separately formed from the inertia sensor 21. In addition, since the mounting mechanism of the output unit 24 is used in common as the inertia sensor 21, it is possible to make a simple structure.

In the embodiment, the output unit 24 is mounted on the user. The output sound ensures stimulation of the senses of the user. The achievement or the non-achievement with respect to the target is surely transferred to the user. In addition, the same is true for using the light or the vibration instead of the sound.

The target value is input to the swing evaluation apparatus 11 from the touch screen panel 18. The user can designate the target value. In addition, the user can change the target value in accordance with the user's own degree of attainment.

### 3. Operation of Swing Evaluation Apparatus According to Second Embodiment

The group evaluation unit 35 may specify the total of indexes which are imparted for at least one of the swings so as to indicate the degree of achievement with respect to the target value. For example, in a case where the target value of the swing speed is set to be 130 km, the swing evaluation unit 33 may impart 20 points to the swing which exceeds 130 km, impart 10 points to the swing which exceeds 120 km, impart 2 points to the swing which exceeds 110 km, and impart 0 points to the swing which is equal to or less than 110 km. In this way, at least one of the swings is evaluated in accordance with the degree of achievement in stages. The entirety of swing groups is specifically evaluated.

### 4. Operation of Swing Evaluation Apparatus According to Other Embodiments

As described above, in the swing evaluation apparatus 11, the target value may be input thereto from the touch screen panel 18, and the swing evaluation unit 33 may set the target value in accordance with the evaluation of the swing group. When the swing which has achieved the target value exceeds a certain ratio (for example, 90%), the target value may be set to be higher. With this, it is possible to easily prevent that the next degree of achievement from reaching 100%. In contrast, when the target value is lower than the low ratio of the swings which have achieved the target value (for example, 30%), the target value may be lowered. In this way, the next evaluation is enhanced, and thus it is possible to contribute to maintaining motivation. In addition, the target value may be set in accordance with an expected achievement rate (a ratio of the swings which have achieved the target value in the swing group).

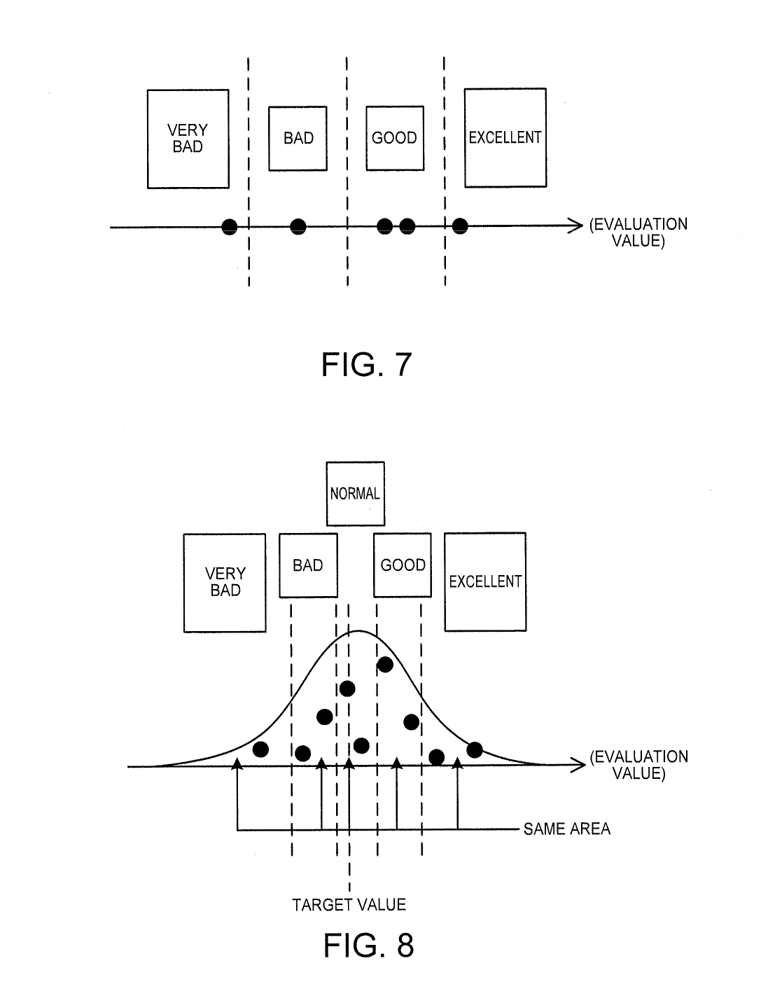

As illustrated in FIG. 7, in order to evaluate the analytical value, the reference value is set in a range at regular intervals. For example, as described above, the target value of the swing speed is set to be 130 km, the first reference value of the swing speed is set to be 120 km, and the second reference value of the swing speed is set to be 110 km. Here, for example, if the analytical value is equal to or higher than 140 km, the analytical value is determined to be “excellent”, if the analytical value is equal to or higher than 130 km, the analytical value is determined to be “good”, if the analytical value is higher than 120 km and does not achieve the target value, the analytical value is determined to be “bad”, and if the analytical value is equal to or lower than 120 km, the analytical value is determined to be “very bad”.

As illustrated in FIG. 8, in order to evaluate the analytical value, the swing evaluation unit 33 may set a reference value based on a probability density function. The reference value is set such that integrated values of the probability density function are equal to each other. As the probability density function, for example, in a case of the swing speed, it is preferable to use a normal distribution, and in a case of the number of successes of n-times trials, it is preferable to use a binomial distribution. In this way, a probability density function is properly selected in accordance with the selected items. A parameter of the probability density function may be input from, for example, the touch screen panel 18.

In a case where the swing reaction time is evaluated, when the notifying unit 34 receives the evaluation result from the swing evaluation unit 33, the notice signal may be output to the output unit 24 without waiting until the end of the swing. In this way, the user can recognize the achievement or non-achievement with respect to the target during the swing.

Meanwhile, the embodiment is described in detail as above, but those skilled in the art can easily understand that various modifications which do not substantially depart from new matters and advantages of the invention are possible. Therefore, all such Modification Examples are included in the invention. For example, in the specification or drawings, at least once, terms listed together with different terms having broader or the same meaning can be replaced with different terms in any place in the specification or drawings. In addition, configurations and operations of the sensor device 12, the host terminal 13, the mount member 15, the smart phone 16, the display panel 17, the touch screen panel 18, or the like can be modified in various ways without being limited to the description of the embodiments.

The entire disclosure of Japanese Patent Application No. 2014-207371, filed Oct. 8, 2014 is expressly incorporated by reference herein.

What is claimed is:

1. A swing evaluation apparatus comprising:
an analysis unit which calculates an analytical value relating to a swing based on an output of an inertia sensor;
an evaluation unit which evaluates a degree of achievement of the analytical value with respect to a set target value; and
a notifying unit which notifies a user of an evaluation result by changing types of notification in accordance with the degree of achievement.

2. The swing evaluation apparatus according to claim 1,
wherein the notifying unit notifies the user of the evaluation result by using at least one of sound, light, and vibration.

3. The swing evaluation apparatus according to claim 1,
wherein the notifying unit is integrally provided with a unit in which the inertia sensor is accommodated.

4. The swing evaluation apparatus according to claim 1,
wherein the notifying unit is separately provided from a unit in which the inertia sensor is accommodated.

5. A swing evaluation apparatus comprising:
an analysis unit which calculates analytical values relating to a plurality of swings based on an output of an inertia sensor;
a group evaluation unit which evaluates achievement or non-achievement of the analytical value for at least one of the plurality of swings with respect to a set target value, and evaluates a degree of achievement with respect to the target value as a swing group; and
a notifying unit which notifies a user of the degree of achievement.

6. The swing evaluation apparatus according to claim 5,
wherein the group evaluation unit updates the target value in accordance with an evaluation of the swing group.

7. The swing evaluation apparatus according to claim 1, further comprising an input unit which inputs the target value.

8. The swing evaluation apparatus according to claim 5, further comprising an input unit which inputs the target value.

9. The swing evaluation apparatus according to claim 5,
wherein the evaluation unit performs evaluation in accordance with the degree of achievement in stages.

10. The swing evaluation apparatus according to claim 1,
wherein the notifying unit performs notification when receiving the evaluation result from the evaluation unit without waiting until the end of the swing.

11. The swing evaluation apparatus according to claim 5,
wherein the notifying unit performs notification when receiving the evaluation result from the evaluation unit without waiting until the end of the swing.

12. A swing evaluation method comprising:
calculating an analytical value relating to a swing based on an output of an inertia sensor;
evaluating a degree of achievement of the analytical value with respect to a set target value; and
notifying a user of an evaluation result by changing types of notification in accordance with the degree of achievement.

13. The swing evaluation method according to claim 12,
wherein in the notifying, the notifying is performed by using at least one of sound, light, and vibration.

14. A swing evaluation method comprising:
calculating analytical values relating to a plurality of swings based on an output of an inertia sensor;
evaluating achievement or non-achievement of the analytical value for at least one of the plurality of swings with respect to a set target value, and evaluating a degree of achievement with respect to the target value as a swing group; and
notifying a user of the degree of achievement.

15. The swing evaluation method according to claim 14,
wherein in the evaluating, the target value is updated in accordance with an evaluation of the swing group.

16. The swing evaluation method according to claim 12, further comprising inputting the target value.

17. The swing evaluation method according to claim 14, further comprising inputting the target value.

18. The swing evaluation method according to claim 14,
wherein in the evaluating, evaluation is performed in accordance with the degree of achievement in stages.

19. The swing evaluation method according to claim 12,
wherein in the notifying, when the evaluation result is received, the notification is performed without waiting until the end of the swing.

20. The swing evaluation method according to claim 14,
wherein in the notifying, when the evaluation result is received, the notification is performed without waiting until the end of the swing.
